(19) United States
(12) Patent Application Publication
(10) Pub. No.: US 2010/0148042 A1
(43) Pub. Date: Jun. 17, 2010

(54) SENSOR

(75) Inventors: I-Ming Chen, Singapore (SG); Kwang Yong Lim, Singapore (SG); Young Koon Goh, Singapore (SG); Song Huat Yeo, Singapore (SG); Been-Lim Duh, Singapore (SG)

Correspondence Address: MERCHANT & GOULD PC, P.O. BOX 2903, MINNEAPOLIS, MN, 55402-0903, US

(73) Assignee: Nanyang Technological University, Singapore (SG)

(21) Appl. No.: 12/600,775

(22) PCT Filed: Jan. 18, 2008
(86) PCT No.: PCT/SG2008/000022

§ 371 Date: Nov. 18, 2009

Related U.S. Application Data
(60) Provisional application No. 60/938,804, filed on May 18, 2007.

(51) Int. Cl. G01D 5/34; G01B 11/26

(52) U.S. Cl. 250/231.1

(57) ABSTRACT

A sensor for angle measurement of a joint is disclosed. The sensor comprises a code strip, a linear encoder configured to detect relative movement between the linear encoder and the code strip, and a microcontroller configured to compute angular rotation of the joint from linear displacement obtained by the relative movement. The relative movement corresponds to rotation of the joint. A corresponding method and system are also disclosed.

### REFERENCE TO RELATED APPLICATION

Reference is made to earlier U.S. provisional patent application No. 60/938,804 filed 18 May 2007 for an invention entitled “Miniature Low-Cost flexible Goniometer for Joint Angle Measurement”, the contents of which are hereby incorporated by reference as if disclosed herein in their entirety, and the priority of which is hereby claimed.

### TECHNICAL FIELD

This invention relates to a sensor for angle measurement and motion capture and relates particularly, though not exclusively, to a method, an apparatus and a system for joint angle measurement and motion capture of the human body.

### BACKGROUND

Goniometers are widely used for measuring body joint angles and capturing body motion for use in many applications ranging from gait biometric data capture for security, apparatus for studying revolutionary anthropology, sports monitoring and engineering, gaming input devices, motion capture for animation and movie making, rehabilitation in medicine, military training, control of robots, and so on. Current human motion capture systems are broadly classified into two categories: vision-based tracking and non-vision-based tracking.

Vision-based sensing systems suffer from occlusion, which makes it difficult to capture simultaneously motion of more that one subject in a field of view. Image recognition and processing in such systems also demand huge computational resources. These systems are typically large and therefore suitable for use only in laboratories or studios. Examples of vision-based motion tracking systems include Vicon, Organic Motions' real-time markerless motion capture, Qualisys and NDI Optotrak Certus Motion Capture Systems.

Examples of non-vision-based commercially available systems include Animazoos' Gypsy-Gyro18, Xsens' Moven and Measurands' Shapewrap. Non-vision-based systems employ sensing technologies that can be generally classified as: inertia measurement units (e.g. accelerometers, gyroscopes), piezo-resistive fabrics (e.g. lycra coated with PPy), conductive fibres, inductive fibre-meshed transducers and optical bend enhanced fibres. A comparison of various characteristics of these sensing technologies is given in Table 1.

TABLE 1

| | Inertia | Piezo- | | Inductive Fiber- | Optical Bend |
|---|---|---|---|---|---|
| | Measurement | Resistive Fabric | Conductive | Meshed Transducer | Enhanced |
| Characteristics | Unit [1] | [2, 3] | Fiber [4] | [5] | Fiber [6, 7] |
| Dynamic response | Medium to Fast | Slow | Slow | Slow to Fast | Slow to Fast |
| Linearity | Non-Linear | Non-Linear | Non-Linear | Non-Linear | Linear |
| Aging | No aging | Yes | Yes | No aging | Slight |
| | | | | | Deterioration |
| Fragility | Rugged | May crack | May crack | Not Fragile | Fragile |
| Packaging ease | Difficulty in | Difficulty in | Difficulty in | Standard | Difficulty in |
| | packaging | packaging | packaging | Equipment | packaging |
| Manufacturing cost | Low | Low | Low | Low | High |
| Susceptibility to | No | No | No | Yes | No |
| electro-magnetic | | | | | |
| interference | | | | | |
| Signal processing | Savitzky-Golay | Regression | Kalman | 5^{th} order | Simple |
| requirement | filter | Methods | Filter | polynomial | |
| | | Required | | fitted with LE | |
| Sensor registration | Not self- | Not self- | Self- | Not Self- | Can be Self- |
| | registering | registering | registering | registering | registering |
| Accuracy | High (rms | Low (gesture | Low (±7°) | High | High |
| | error = 1.6°) | only) | | | |
| Form factor rating | 4 | 1 | 3 | 3 | 3 |
| Signal to noise ratio | Low | Low | Low | Medium | High |

The characteristics compared in Table 1 are explained as follows:
Dynamic response refers to how fast the sensor can produce a measurement. Sensors such as piezo-resistive fabrics may take about 0.5 seconds to produce a useful reading as the sensor suffers from mechanical hysteresis.
Linearity refers to the relation between measured result and the actual angle to be measured. A linear system demands less processing from the embedded system.
Aging depicts the ability of the sensor to maintain its performance over an extended period of time. For example, a piezo-resistive fabric will age and its resistance increases due to oxidation of the piezo-resistive material.
Fragility refers to how fragile the sensor is. Optical bend enhanced sensors made of glass optical fibres, for example, will break when bent to below a minimum bend radius.
Packaging ease denotes how easy it is to package the sensor so that it will not be damaged during deployment. Sensors such as inertial measurement units are encapsulated in a rugged plastic enclosure and are thus much more durable. However they are larger in size, resulting in lower form factor rating.
Manufacturing cost estimates the resources that will be required to produce a single sensor and therefore, its subsequent cost.
Susceptibility to electromagnetic interference (EMI) refers to how immune the sensor is to EMI, and whether it can be used without being affected in an environment where strong electro-magnetic waves are generated.
Signal processing requirement is related to signal to noise ratio and details the filtering technique employed by researchers to obtain useful signals from their sensors.
Sensor registration refers to whether the sensing method adopted can incorporate compensation for variability in gait analysis such as soft tissue artifact, change in weight of the subject, etc.
Accuracy refers to how accurately the joint angle can be measured. Accuracy for the different methods shown ranges from ±1.6° to ±7°.
Form factor rating represents the overall size of the sensor together with the controller unit. This is graded with 5 being the largest and 1 being the smallest.
Signal to noise ratio refers to how susceptible the sensor is to noise generated from undesirable effects such as vibration, temperature changes, etc. Low signal to noise ratio means the sensor picks up noise easily and will thus need a low pass filter to filter out the noise.

As can be seen in Table 1, existing sensors suffer from a variety of problems such as low accuracy (typically ±2°), high cost of the sensing system (in the range of more than $2,000 per sensor), difficulty in extending their proposed methods to the entire body (e.g. can only measure limited motion of upper limbs), poor sensor registration (i.e. difficulty with repeatable placement of the sensor on the human body with every trial), discomfort to patients/subjects while wearing the sensors, and not to being able to provide continuous monitoring of human motion while the patients/subjects carry out daily activities.

There is therefore a need to develop a system whereby required limb motion of the subject/patient can be continuously captured even when the subject/patient is carrying out daily activities, and that preferably addresses the problems of existing sensors.

### SUMMARY

According to a first exemplary aspect there is provided a sensor for angle measurement of a joint. The sensor comprises a code strip, a linear encoder configured to detect relative movement between the linear encoder and the code strip, and a microcontroller configured to compute angular rotation of the joint from linear displacement obtained by the relative movement. The relative movement corresponds to rotation of the joint.

According to another exemplary aspect there is provided a sensor for motion capture of a joint. The sensor comprises a linear encoder, a code strip, and a microcontroller. A specific position of the joint may be recorded by the microcontroller as information associated with specific pulse output by the linear encoder, the pulse output arising from relative movement between the linear encoder and the code strip, the relative movement corresponding to rotation of the joint.

According to a further exemplary aspect there is provided a system for angle measurement and motion capture of a joint. The system comprises at least one sensor based on relative movement between a linear encoder and a code strip. The system further comprises a gateway adapted to synthesize information received from the sensor with biometric data and to transmit synthesized information using a forward kinematics model to an output location.

According to a final exemplary aspect there is provided a method for angle measurement and motion capture of a joint. The method comprises attaching a sensor to a joint; effecting relative movement between a linear encoder and a code strip in the sensor, the relative movement corresponding to rotation of the joint; and converting electrical signals from the linear encoder arising from the relative movement into position information and rotational angle of the joint.

For all exemplary aspects the code strip may be a linear incremental code strip. The code strip may comprise a substrate having a plurality of micro lines thereon. The micro lines may be evenly spaced. The sensor may further comprise a wire having a first end for attaching to the joint and a second end for attaching to one of the linear encoder and the code strip. The microcontroller may be programmed with an identifier for the sensor. The sensor may be in an array of sensors, each sensor having an individual identifier, the array being one of each sensor in the array providing individual sensor data to a gateway, and each sensor for a limb being operatively connected for providing limb data to the gateway. There may also be a guide tube configured to constrain the wire to move only axially. The linear encoder may be adjacent the code strip and may be configured to emit electromagnetic radiation onto the code strip and to sense an interruption to a reflective path of the electromagnetic radiation. The linear encoder may be an optical linear encoder.

### BRIEF DESCRIPTION OF THE DRAWINGS

In order that the present invention may be fully understood and readily put into practical effect, there shall now be described by way of non-limitative example only exemplary embodiments, the description being with reference to the accompanying illustrative drawings.

In the drawings:

FIG. 1 is a block diagram of an exemplary goniometer system;

FIG. 2 is a perspective view of an exemplary mounting of sensors on a body;

FIG. 3 is a schematic side view of an exemplary embodiment having a moving linear encoder and a fixed linear code strip;

FIG. 4 is a schematic diagram of types of encoders;

FIG. 5 is a plan view of an absolute code strip;

FIG. 6 is a plan view of an incremental code strip;

FIG. 7 is a perspective view of an exemplary sensor strip;

FIG. 8 is a schematic of the output of Channel A and B of an exemplary linear encoder;

FIG. 9 is a perspective view of an exemplary sensor;

FIG. 10 is a perspective view of a linear code strip placement and a linear encoder assembly of the sensor in FIG. 9;

FIG. 11 is a schematic side view of another exemplary embodiment having a fixed linear encoder and a moving linear code strip;

FIG. 12 is a block diagram of an exemplary electrical circuitry;

FIG. 13 is a flowchart of a process for converting linear displacement to joint angle;

FIG. 14 is a schematic representation of a way of measuring angular displacement;

FIG. 15 is a schematic representation of a way of translating linear displacement to angular displacement;

FIG. 16 is a graph comparing commercially available goniometers with the exemplary sensor of FIG. 9;

FIG. 17 is a flowchart of use of the exemplary embodiment of FIG. 3;

FIG. 18 is an illustration of an exemplary embodiment of a sensor array; and

FIG. 19 is an illustration of an alternative sensor array.

### DETAILED DESCRIPTION OF THE EXEMPLARY EMBODIMENTS

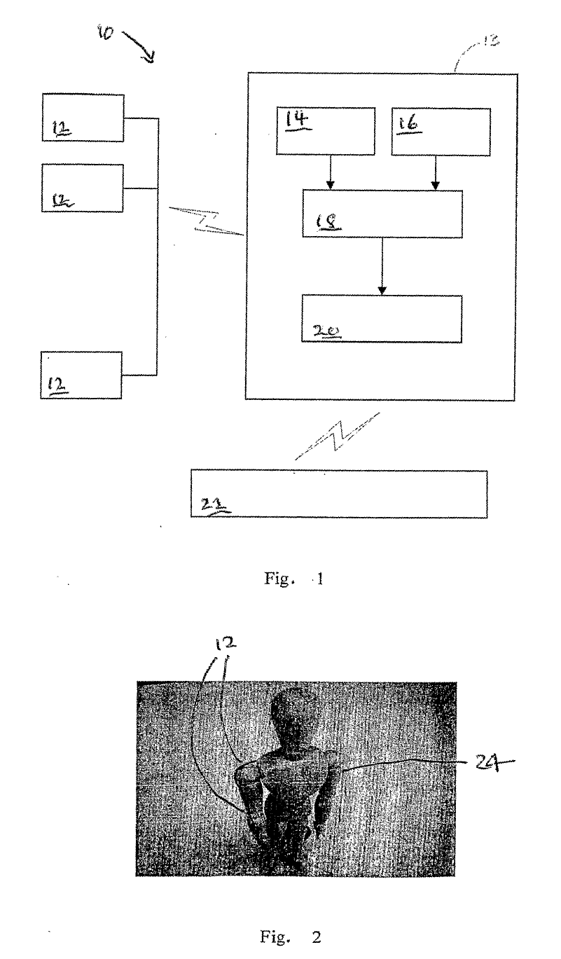

A system 10 which is an exemplary embodiment of the invention will now be described. The system 10 comprises at least one sensor in the form of a strip, the strip being packaged with a low-power embedded controller. Together, the strip and embedded controller are referred to as a strip sensor 12. Where desired, a plurality of strip sensors 12 may be used, as shown in FIGS. 1 and 2.

The strip sensor 12 is adapted to send information of a joint to which it is attached. The information typically comprises Euler angles with respect to reference x-, y- and z-axes. The joint information is sent to a gateway 13, such as a Personal Digital Assistant (PDA)-type device. The gateway 13 is adapted to synthesize information received from the strip sensor 12 with customizable biometric data 14, taking into account a sensor web configuration 16. Using a forward human kinematics model 18 embedded into the gateway 13, synthesized information is then transmitted through a network communication system 20 to an output location 22 such as a remote robot, a virtual reality system or a personal computer.

For example, as shown in FIG. 2, a sensor 12 mounted on a body joint 24 (e.g. a shoulder) of a patient/subject will send the Euler angles of the shoulder to the gateway 13. The gateway 13 then processes the Euler angles based on the forward kinematics model and displays the motion of the patient/subject in three dimensions (3-D). Since each strip sensor 12 is able to give an output orientation of each human joint in the form of Euler angles, the number of sensors 12 required is reduced, making the system more robust.

As mentioned, each strip sensor 12 comprises a strip interfaced and packaged with a low-power microcontroller. The microcontroller is adapted to allow customization of the sensor 12 according to the patient/subject's biometric data, and to provide a wireless sensor network interface to the gateway 13 when a plurality of strip sensors 12 (each having its own microcontroller) are deployed at various locations on a patient/subject's body. With such a distributed system comprising a plurality of strip sensors 12, real-time performance coupled with portability over long periods of activity can be achieved.

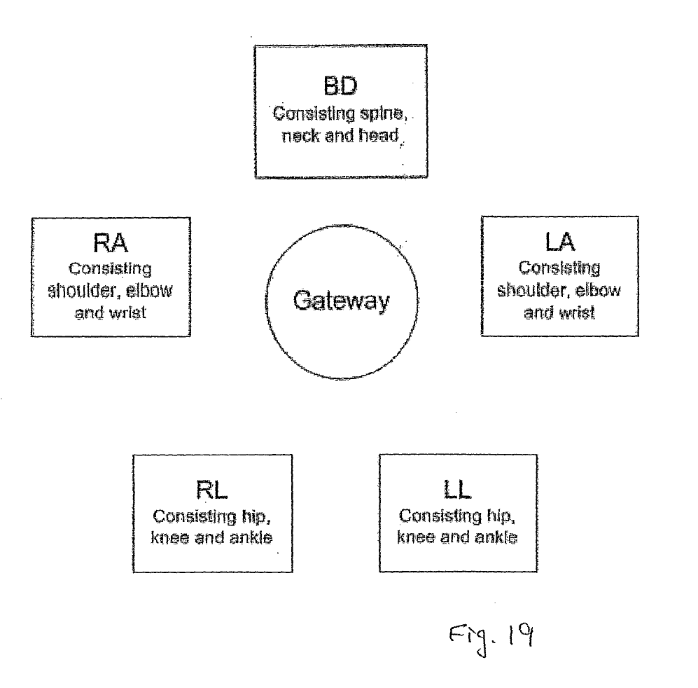

As shown in FIGS. 18 and 19, each strip sensor 12 will have a predetermined identifier programmed into the microcontroller. In FIG. 18 the configuration is modular. Each joint strip sensor 12 has a two character identifier where, for example, HD is head, NK is neck, SP is spine, SR is shoulder-right, SL is shoulder-left, and so forth. All strip sensors 12 will individually send their identifier with the joint angles to the gateway 13. In FIG. 19, each limb is considered a module instead of each individual strip sensor 12. For example, the right arm will have sensors for the right shoulder, right elbow and right wrist. The sensors are operatively connected by, for example, relatively thin wires sewn or woven into the suit.

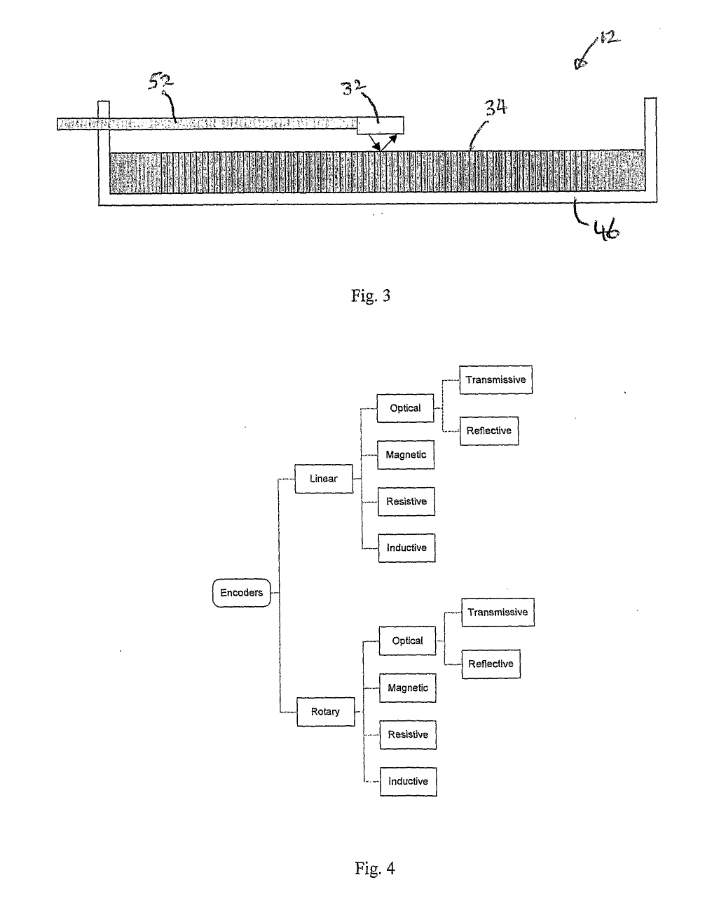

The strip sensor 12 is preferably adapted to allow relative movement between a code strip 34 and an encoder 32 adjacent the code strip 34. A first exemplary embodiment is shown in FIG. 3. There are many types of encoders, each using a different way of measuring linear and angular displacement. Encoders are broadly categorized into linear and rotary types, as shown in FIG. 4. Preferably, the strip sensor 12 comprises a linear encoder 32. The linear encoder 32 is a miniature optical sensor that emits infra-red light onto the code strip 34 and outputs a pulse when its receiver senses an interruption to a reflective path of that infra-red light. Frequencies of light other than infrared may be used; and forms of electromagnetic radiation other than light may be used.

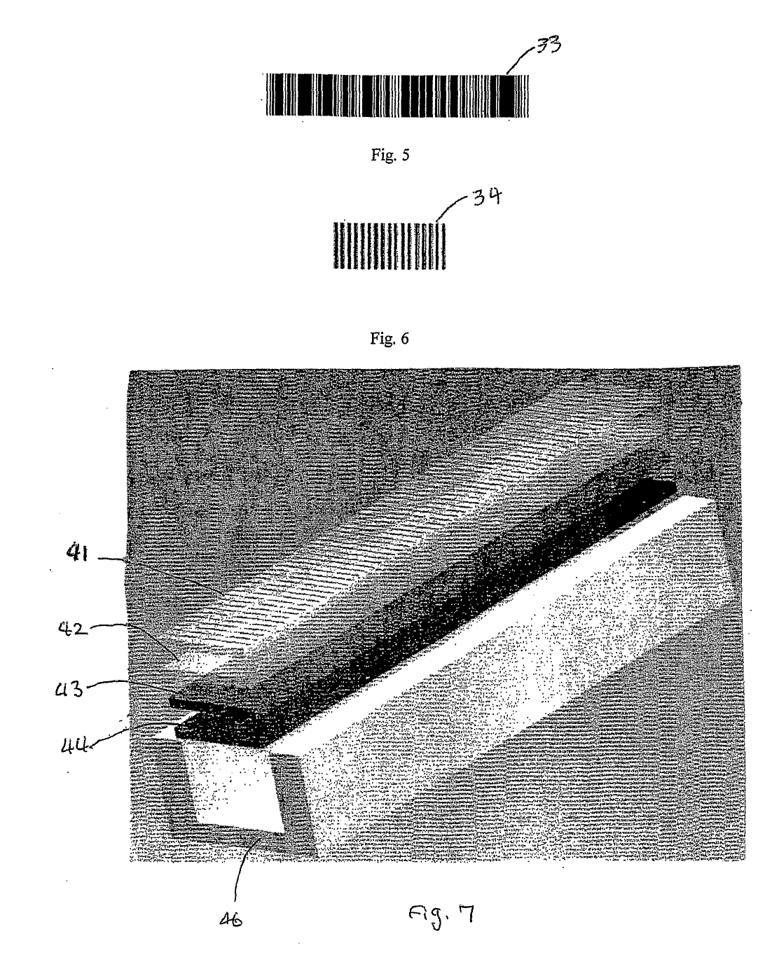

FIGS. 5 and 6 show an absolute code strip 33 and an incremental code strip 34 respectively. Preferably, the strip sensor 12 comprises an incremental linear code strip 34 wherein markings on the strip are evenly spaced. The linear code strip 34 is preferably a module comprising four layers. As shown in FIG. 7, these are preferably a top layer comprising a printed plastic substrate 41 having a plurality of micro lines engraved on it by a photo-plotter, a layer of optical grade adhesive 42, a base reflective strip 43 made of a reflective material, and another layer of adhesive 44.

To control the optical properties of the linear code strip 34, the top layer of the linear code strip 34 comprising the printed plastic substrate 41 is preferably segmented by the engraved micro lines so that the optical sensor of the linear encoder 32 can detect changes in received reflection. The adhesive 42 used to bond the printed substrate 41 to the reflective layer 43 is preferably of an optical grade so as to allow the emitted infra-red light to be transmitted to the reflective layer 43 without much loss. The reflective strip 43 is preferably highly reflective so that it can reflect the emitted infra-red light back to the receiver of the optical sensor in the linear encoder 32. The fourth layer comprising adhesive 44 is used as a bonding layer to adhere the linear code strip 34 module to a base structure 46. Upon laminating the four layers 41, 42, 43, 44 together with the base structure 46, the linear code strip 34 module will be adhered onto the base structure 46.

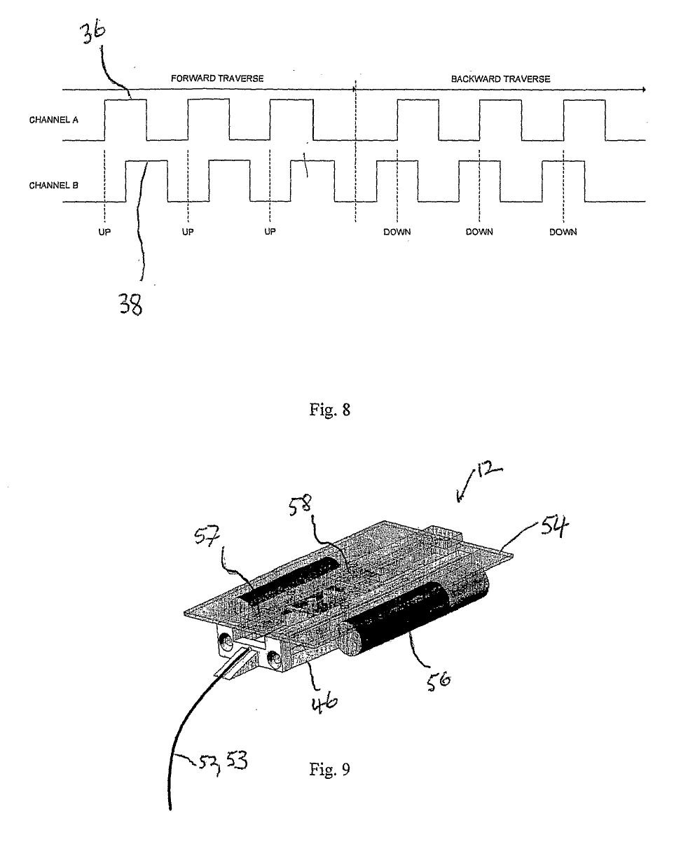

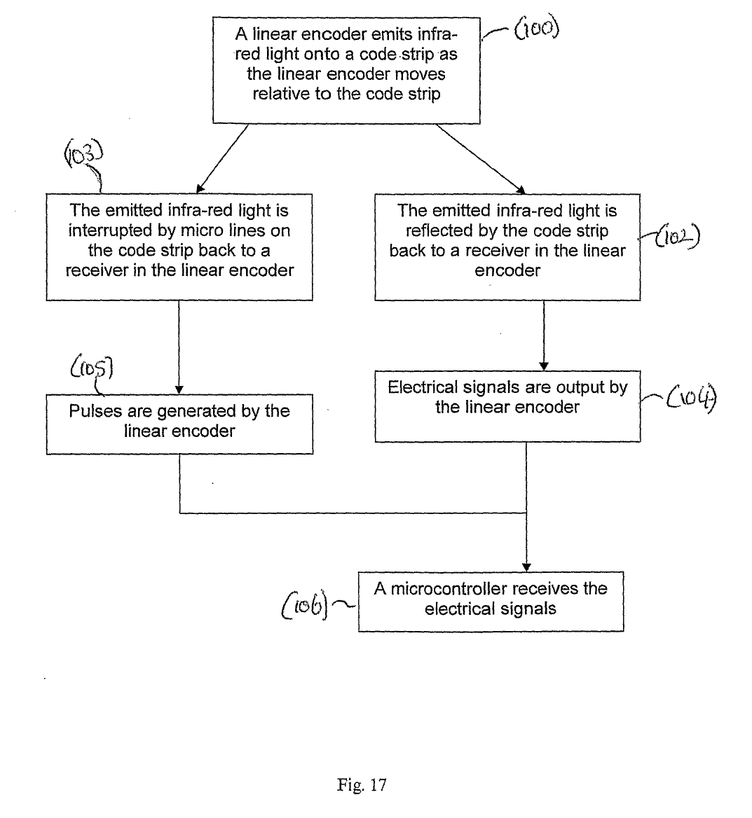

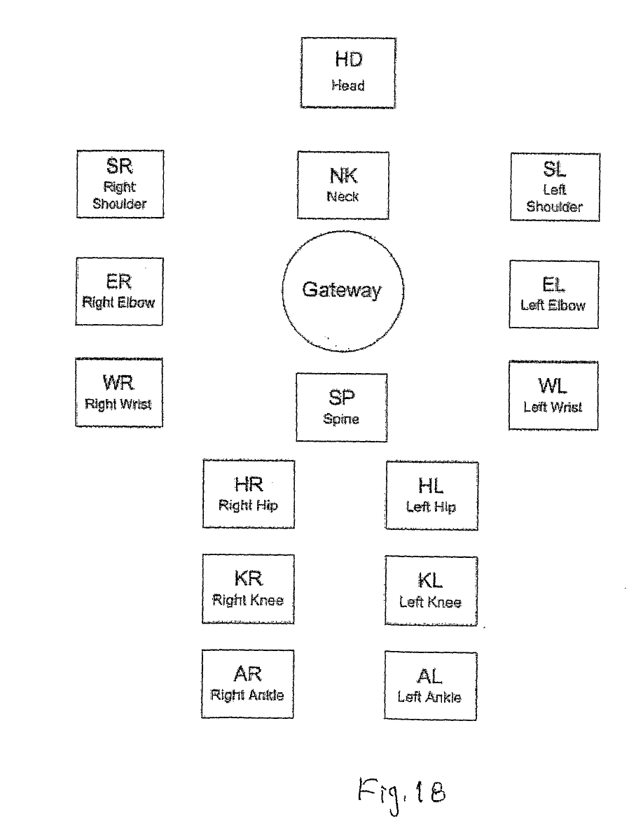

In use (FIG. 17), infra-red light from the linear encoder 32 is emitted onto the linear code strip 34 as the linear encoder 32 moves relative to the linear code strip 34 (100). Any reflected light is captured by the receiver in the linear encoder 32, as shown in FIG. 3. If the infra-red light is indeed reflected (102), signal processing circuitry in the sensor 12 will output two electrical signals (i.e. channels A and B) that are 90° out of phase with each other (104), as shown in FIG. 8. If the emitted infra-red light is interrupted by the micro lines on the code strip 34 (103), pulses 36, 38 are generated in the electrical signals (105). The number of pulses is therefore indicative of the number of micro lines crossed. Accordingly, relative displacement between the linear encoder 32 and the code strip 34 can be determined because spacing between the engraved micro lines is known or can be pre-determined.

The pulses 36, 38 are output to the microcontroller (106) and, based on the pulses 36, 38, a position detector in the microcontroller determines which portion of the linear code strip 34 the encoder 32 is directly located at. This may be done by determining the number of pulse changes detected by the linear encoder 34. The position detector is also configured to determine a location within the length of the linear encoder 32 that is associated with the portion whereat the encoder 32 is located with respect to the code strip 34.

The linear code strip 34 when used with the linear encoder 32 thus provides a means of indicating distance traveled by the linear encoder 32 as it moves over the linear code strip 34. The two electrical pulses 36, 38 that are out of phase with each other also serve to indicate travel direction of the linear encoder 32 with respect to the linear code strip 34, as shown in FIG. 8.

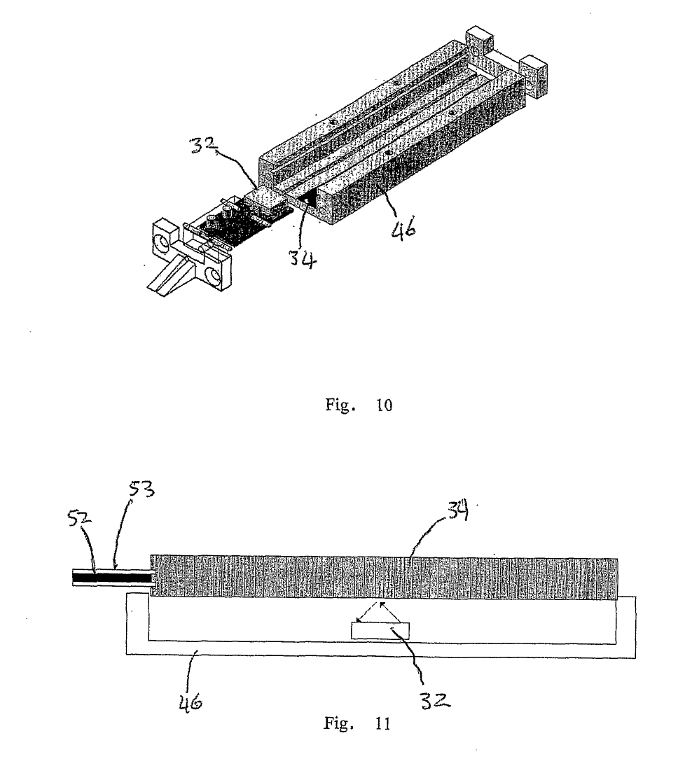

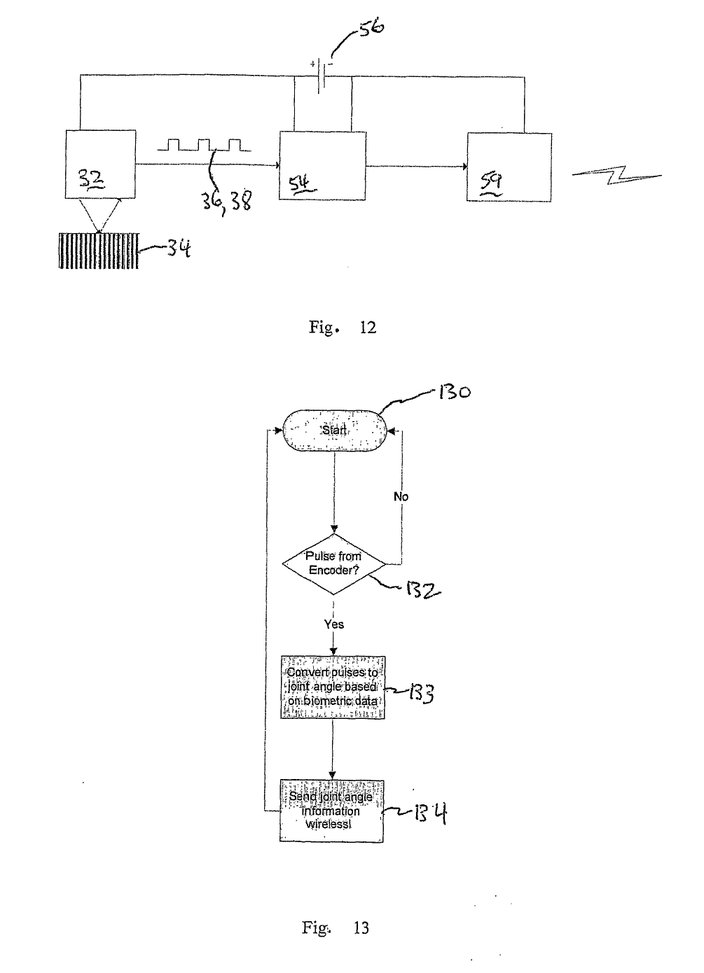

The linear encoder 32 is preferably moved over the linear code strip 34 by movement of a wire 52 affixed to the linear encoder 32, as shown in FIG. 3. The wire 52 may be made of stainless steel and has a diameter of less than 1.5 mm. Alternatively, an appropriate cable or fibre may be used in place of the wire 52. A plastics (e.g. Teflon) guide tube 53 (shown in FIG. 9) is preferably used to guide and constrain movement of the wire 52 to only 1 degree-of-freedom, i.e., only axial/linear movement is permitted. The wire 52 is attached to a body joint of the patient/subject, such as an elbow. As the elbow bends, the wire/cable/fibre will be displaced along the circumference of the joint angle. The radius about the body joint is assumed to be constant as the wire wraps around the joint. As the body joint bends, it causes skin over the joint to stretch. This stretch is translated into a linear displacement captured by the wire 52. The linear displacement of the wire 52 (and accordingly also the linear encoder 32) is converted to electrical pulses 36, 38 which can be captured and stored by the microcontroller.

Between a first position of the joint and a second position of the joint, the second position being angularly displaced from the first position, the microcontroller may keep count of the number of pulse changes received from the linear encoder 32, this being known as a threshold number of pulses. The first position and the second position may be known reference locations based on indicative pulses received by the microcontroller. From the pulse pattern obtained from the two channels A and B, the microcontroller can also determine joint movement direction, i.e., whether the joint is moving from the first position to the second position or vice versa.

The microcontroller may also be configured to determine a number of times the actual detected number of pulses exceeds the threshold number of pulses. This is of especial use in cases where the first position and the second position represent normal allowable limits of joint motility, such that a pulse count exceeding the threshold number may serve to indicate unnatural joint flexion arising from injury, for example. The maximum and minimum pulses are values that can be programmed into each strip sensor 12 so that the strip sensor 12 can provide data for display giving the present joint angle with respect to the maximum and minimum pulses as a percentage, for example. This may be of assistance in providing a user-friendly display of the joint angle compared with the actual joint angle displayed numerically.

The base structure 46 is preferably made of a rigid plastic material. Its function is to allow the linear encoder 32 to traverse above the linear code strip 34 while maintaining a constant gap between the linear code strip 34 and linear encoder 32. As shown in FIG. 9, the sensor is used with batteries 56 and includes a printed circuit board 54 with the microcontroller unit (MCU) 57 and wireless interface 58. FIG. 10 provides an exploded assembly view of the sensor 12 without the printed circuit board 54, showing where the linear encoder 32 and the code strip 34 are placed with respect to the base structure 46.

A second exemplary embodiment of the linear encoder 32 and code strip 34 is shown in FIG. 11. In this embodiment, the linear encoder 32 is attached to the base structure 46 while the linear code strip 34 is connected to the wire 52 that is attached to the body joint. The linear code strip 34 is thus configured to move relative to the linear encoder 32 and the base structure 46. The base structure 46 allows the linear code strip 34 to traverse above the linear encoder 32 while maintaining a constant gap between the code strip 34 and linear encoder 32.

A block diagram of electrical circuitry for converting linear distance to a joint angle (based on output of the linear encoder 32 with respect to the code strip 34) is shown in FIG. 12. FIG. 13 shows the corresponding sequence of process steps. The low-power microcontroller 54 has embedded software (i.e. firmware) that reads channel A and B pulses 36, 38 (132) from the encoder 32 and converts a total directional count of the number of pulses to joint angles (133). The newly computed joint angles are then sent wirelessly over to a gateway (i.e. personal digital assistant, personal computer, etc.) via a low power radio transmitter/receiver 59 (134).

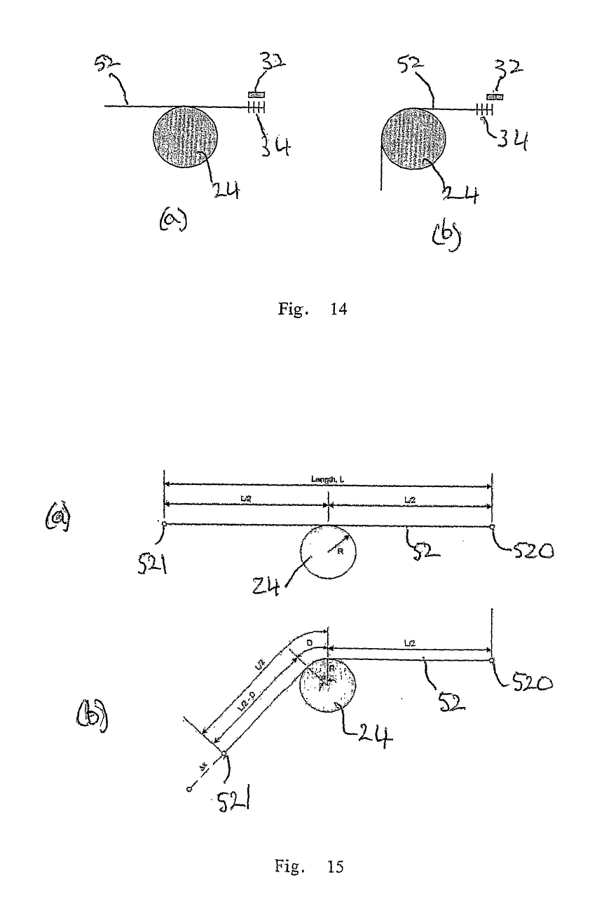

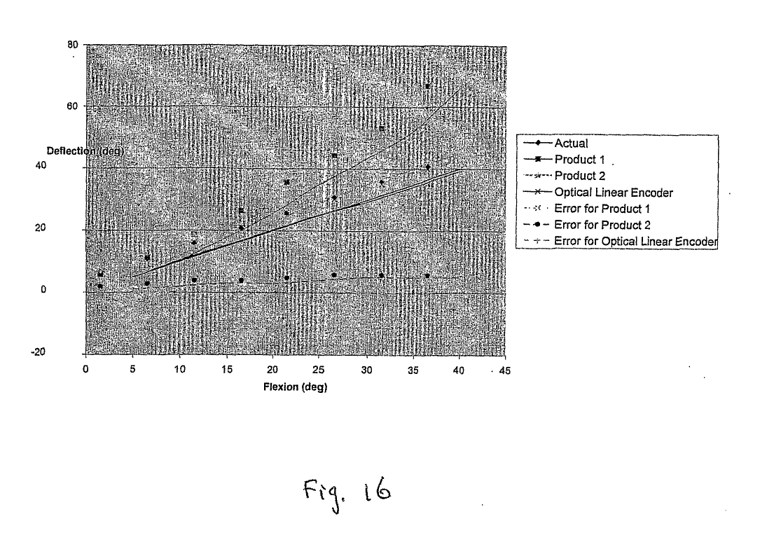

FIGS. 14 and 15 demonstrate how joint angles may be obtained from linear displacement of the wire 52. As shown in FIG. 14(a), the wire 52 is attached to a body joint 24 as well as to the code strip 34. As the joint 24 is bent (FIG. 14(b)), the wire 52 wraps around the joint 24 and consequently displaces the code strip linearly with respect to the linear encoder 32.

FIG. 15(a) shows a schematic representation of the wire 52 having a length L attached to the joint 24, the wire 52 being in two portions of equal length on either side of the joint 24. A movable end 521 of the wire 52 is attached to either the linear encoder 32 or the code strip 34 (depending on the embodiment of the strip sensor 12 used).

As the joint 24 is bent by an (as yet unknown) angle α (FIG. 15(b)), the movable end 521 is displaced by a length Δx. The following equations give the relationship between the angle α, the distance Δx and the radius R of the joint, where D is the angular displacement arising from the bending angle α.

$$\begin{matrix}Δ x = D & ( 1 ) \\ D = \frac{α}{360 °} \times 2 R \times π & ( 2 ) \\ α = \frac{D}{2 π R} \times 360 ° & ( 3 )\end{matrix}$$

The microcontroller uses these equations to convert linear displacement Δx (as obtained through the linear encoder 32) into the bending angle α, given that R is known.

Experimental verification of how the sensor 12 performs with respect to commercially available products was performed and the results are shown in FIG. 16, where OLE (optical linear encoder) refers to the sensor system 10 as described above. It is evident that the sensor system 10 provides results closest to clinically observed data marked as “Actual” in FIG. 16.

Whilst there has been described in the foregoing description exemplary embodiments, it will be understood by those skilled in the technology concerned that many variations or modifications in details of design or construction may be made without departing from the present invention.

1. A sensor for angle measurement of a joint, the sensor comprising: a code strip; a linear encoder configured to detect relative movement between the linear encoder and the code strip; and a microcontroller configured to compute angular rotation of the joint from linear displacement obtained by the relative movement; wherein the relative movement corresponds to rotation of the joint.

2. A sensor as claimed in claim 1, wherein the linear encoder is an optical linear encoder.

3. A sensor as claimed in claim 2, wherein the code strip is a linear incremental code strip.

4. A sensor as claimed in claim 3, wherein the code strip comprises a substrate having a plurality of micro lines thereon.

5. (canceled)

6. A sensor as claimed in claim 1, further comprising a wire having a first end for attaching to the joint and a second end for attaching to one of: the linear encoder and the code strip.

7. A sensor as claimed in claim 1, wherein the microcontroller is programmed with an identifier for the sensor.

8. A sensor as claimed in claim 7, wherein the sensor is in an array of sensors, each sensor having an individual identifier, the array being one of: each sensor in the array providing individual sensor data to a gateway, and each sensor for a limb being operatively connected for providing limb data to the gateway.

9. A sensor as claimed in claim 6, further comprising a guide tube configured to constrain the wire to move only axially.

10. A sensor as claimed in claim 1, wherein the linear encoder is adjacent the code strip and is configured to emit electromagnetic radiation onto the code strip and to sense an interruption to a reflective path of the electromagnetic radiation.

11-20. (canceled)

21. A system for angle measurement and motion capture of a joint, the system comprising at least one sensor based on relative movement between a linear encoder and a code strip, the system further comprising a gateway adapted to synthesize information received from the sensor with biometric data and to transmit synthesized information using a forward kinematics model to an output location.

22. A system as claimed in claim 21, wherein the linear encoder is an optical linear encoder.

23. A system as claimed in claim 22, wherein the code strip is a linear incremental code strip.

24. A system as claimed in claim 23, wherein the code strip comprises a substrate having a plurality of micro lines thereon.

25. (canceled)

26. A system as claimed in claim 10, further comprising a wire having a first end for attaching to the joint and a second end for attaching to one of: the linear encoder and the code strip.

27. A system as claimed in claim 21, wherein the microcontroller is programmed with an identifier for the sensor.

28. A system as claimed in claim 27, wherein the sensor is in an array of sensors, each sensor having an individual identifier, the array being one of: each sensor in the array providing individual sensor data to a gateway, and each sensor for a limb being operatively connected for providing limb data to the gateway.

29. A system as claimed in claim 26, further comprising a guide tube configured to constrain the wire to move only axially.

30. (canceled)

31. A system as claimed in claim 21, wherein the linear encoder is adjacent the code strip and is to emit electromagnetic radiation onto the code strip and to sense an interruption to a reflective path of the electromagnetic radiation.

32. A method for angle measurement and motion capture of a joint, the method comprising:
attaching a sensor to a joint;
effecting relative movement between a linear encoder and a code strip in the sensor, the relative movement corresponding to rotation of the joint;
converting electrical signals from the linear encoder arising from the relative movement into position information and rotational angle of the joint.

33. A method as claimed in claim 32, wherein the linear encoder is an optical linear encoder.

34. A method as claimed in claim 33, wherein the code strip is a linear incremental code strip.

35. A method as claimed in claim 34, wherein the code strip comprises a substrate having a plurality of micro lines thereon.

36. (canceled)

37. A method as claimed in claim 32, further comprising a wire having a first end for attaching to the joint and a second end for attaching to one of: the linear encoder and the code strip.

38. A method as claimed in claim 37, wherein the microcontroller is programmed with an identifier for the sensor.

39. A method as claimed in claim 38, wherein the sensor is in an array of sensors, each sensor having an individual identifier, the array being one of: each sensor in the array providing individual sensor data to a gateway, and each sensor for a limb being operatively connected for providing limb data to the gateway.

40-41. (canceled)
